(19) United States
(12) Patent Application Publication
(10) Pub. No.: US 2004/0122660 A1
(43) Pub. Date: Jun. 24, 2004

(54) Creating taxonomies and training data in multiple languages

(75) Inventors: Keh-Shin Fu Cheng, Mahopac, NY (US); Stephen C. Gates, (US)

Correspondence Address: Eric W. Petraske, 68 Hawleyville Road, Bethel, CT, 06801, US

(73) Assignee: International Business Machines Corporation, Armonk, NY

(21) Appl. No.: 10/324,919

(22) Filed: Dec. 20, 2002

(51) Int. Cl. G06F 17/28

(52) U.S. Cl. 704/10

(57) ABSTRACT

The problem of creating of taxonomies of objects, particularly objects that can be represented as text in various languages, and categorizing such objects is addressed by a method for taking the training documents generated in a first language, translating it to a target language, and then generating from a plurality of training documents one or more sets of features representing one or more categories in the target language. The method includes the steps of: forming a first list of items such that each item in the first list represents a particular training document having an association with one or more elements related to a particular category; developing a second list from the first list by deleting one or more candidate documents which satisfy at least one deletion criterion; translating the documents in the second list from the source language to the target language, and extracting the one or more sets of features from the translated second list using one or more feature selection criteria.

### FIELD OF THE INVENTION

The field of the present invention is the creation of taxonomies of objects, particularly objects that can be represented as text in various languages, and to categorizing such objects.

### BACKGROUND OF THE INVENTION

In a copending patent application, copending application [DOCKET NUMBER: YOR920020149US1], we described a generalized method for automated construction of large-scale taxonomies and for automated categorization of large-scale document collections such as the World Wide Web. That system of copending application [DOCKET NUMBER: YOR920020149US1] is incorporated herein by reference in entirety for all purposes.

It would be advantageous to extend that system to include creation of taxonomies and categorization in multiple languages. One such method is to use the techniques of copending application [DOCKET NUMBER: YOR920020149US1] in each target language. A second method is to translate each test document into the source language used in building the system of copending application [DOCKET NUMBER: YOR920020149US1] and use the corresponding source-language categorizer to categorize each translated test document. This method works well when the quality of translation is high, such as in manual translation or machine translation between relatively similar source and target languages. However, it may not be possible to apply these methods to many topics in languages where large numbers of documents are not available for training purposes, or where the quality of machine translation is somewhat lower.

The present invention provides another alternative that includes using machine translation systems for translating training documents in one language to another target language. We have found this particularly advantageous when using English as the source language, because the number of documents on the Web in English is extremely high and the quality of translators from English to many target languages seems to be significantly higher than the quality of translation in the reverse direction. Also, the cost of obtaining training documents is generally much higher than the cost of machine translating them, so methods that re-utilize training documents from one language in building training documents in another language are often more cost-efficient.

### SUMMARY OF THE INVENTION

An aspect of the present invention is to provide methods, apparatus and systems for constructing a taxonomy in multiple languages. This invention includes the use of data collected in one language and automated translation techniques to build taxonomies and categorization systems in other languages.

In a particular aspect, the present invention provides a method for taking the training documents generated in a first language, translating them to a target language, and then generating from a plurality of training documents one or more sets of features representing one or more categories in the target language. The method includes the steps of: forming a first list of items such that each item in the first list represents a particular training document having an association with one or more elements related to a particular category; developing a second list from the first list by deleting one or more candidate documents which satisfy at least one deletion criterion; translating the documents in the second list from the source language to the target language, and extracting the one or more sets of features from the translated documents in the second list using one or more feature selection criteria.

It is advantageous for the method to include in the step of translating the documents the step of using a machine translation system to translate the documents.

It is also advantageous to include in the step of extracting the one or more sets of features from the translated second list the steps of: creating a dictionary of features for the target language; converting each document in the translated second list to a corresponding mathematical representation; and developing a third list from the translated second list by deleting one or more candidate documents which satisfy at least one deletion criterion.

### BRIEF DESCRIPTION OF THE DRAWINGS

The invention is best understood from the following detailed description when read in connection with the accompanying drawings, in which:

FIG. 1 illustrates an example of an overall process in accordance with the present invention;

FIG. 2 shows the method of selecting training documents.

FIG. 3 describes creation of a dictionary of terms in a given language.

FIG. 4 shows a method of combining categories created by different process.

FIG. 5 shows a method for “centroid boosting” that improves the situation in cases where the translation is not as idiomatically correct as desired.

### DESCRIPTION OF THE INVENTION

In this invention, we provide general, semi-automated methods, employing a computer system having a processing unit, a storage unit and input/output units, for creating training data in multiple languages for categorization systems and further refinements in the creation of taxonomies. These new methods make it possible to create taxonomies of very large size that can be used to categorize even highly heterogeneous, multilingual document collections (such as the World Wide Web) with near-human accuracy. The term “taxonomy” is used herein consistent with usage in the field to mean “classification structure” or “set of classification categories”.

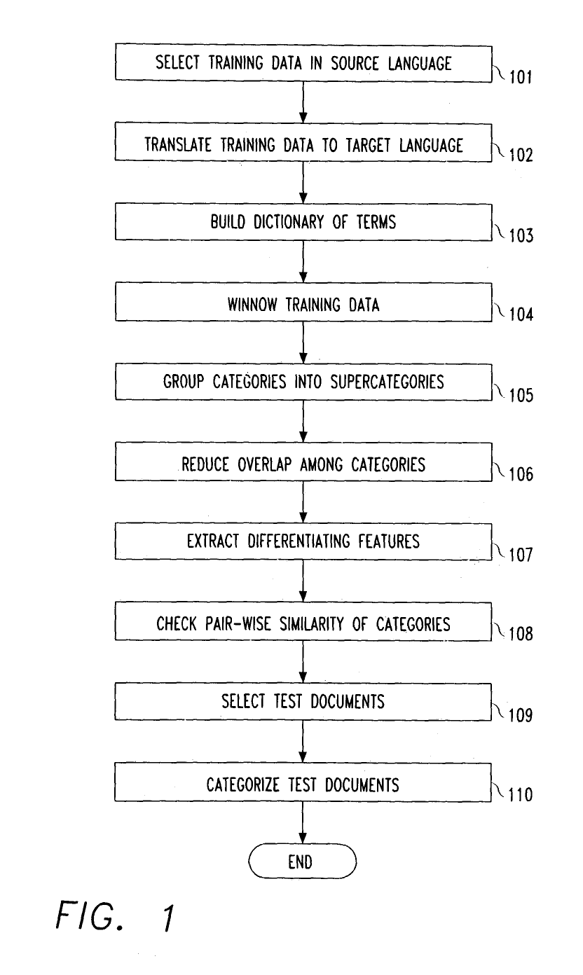

FIG. 1 shows a flow diagram of an embodiment of an example of a taxonomy construction and training data selection process described in this invention. Subsequent figures show details of its steps. It begins with step 101, the selection of a set or sets of training data in the source language for the categorization system. This selection is by any of a variety of means. One such means is to choose a subject area, and then successively divide it into categories, with each category a logical subdivision of the subject area. Training data for each subcategory can then be collected by a number of means, such as submitting queries about each category to a Web search engine or other source of documents. Another such means is to collect a large number of possible category names from a variety of sources. The categories can be, although do not need to be, arranged in any particular order or hierarchy. In general, this step works best if the categories selected are as non-overlapping as possible; i.e., if they are either conceptually as independent of one another as possible, or if they include as few features in common as possible. However, a useful criterion is that the categories be human-selected, so that they ultimately make sense to human users (in contrast to machine-selected categories, which often do not make sense to human users). Training documents can again be selected for each category name using techniques such as search engine queries, use of previously-collected documents on that topic, or similar techniques. A third means for selecting the training data is to use the system of copending application [DOCKET NUMBER: YOR920020149US1] by incorporating the final set of training documents selected by that system for each category of interest.

In step 102, training data is translated from the source language to the target language. This can be by means of manual (human) translation, but can conveniently be done by machine translation techniques. Any of a wide variety of machine translation system (e.g., IBM Websphere Translation Server) can be used.

Optionally, in step 103 a dictionary of terms in the target language can be built from the translated documents.

In step 104, the training data for each category from steps 102 or 103 are winnowed down to a smaller set of training data, by applying some set of criteria. We have found that the most effective criteria are related to ensuring that each training document is purely on one topic, namely that of the category of interest.

In step 105, the training data obtained in step 104 from several related categories are grouped into a supercategory using some supercategory formation criterion. It should be noted that if the categories are all closely related already, this step may not be necessary; however, for large heterogeneous systems of categories it is necessary to enable us both to reduce the computational requirements for solving the problem and to best pick out highly differentiating features (step 107 below).

In step 106, the grouped training data from step 105 are compared and overlap among categories within a supercategory reduced or eliminated.

In step 107, a set of differentiating features is extracted from the training data produced in step 106.

In step 108, pairs of categories with the highest similarity are examined to determine how to reduce the degree of overlap. The goal of this step and the preceding steps is to produce a set of features with a minimum degree of overlap between and among categories and supercategories.

Often, the output of steps 101-108 is used with an automated categorizer to categorize a set of documents. Thus, optionally, in step 109, a set of test documents is selected. This may be by any of several methods; the goal is simply to pick documents that need to be categorized for some particular purpose. In step 110, the test documents are categorized using the features extracted in step 107.

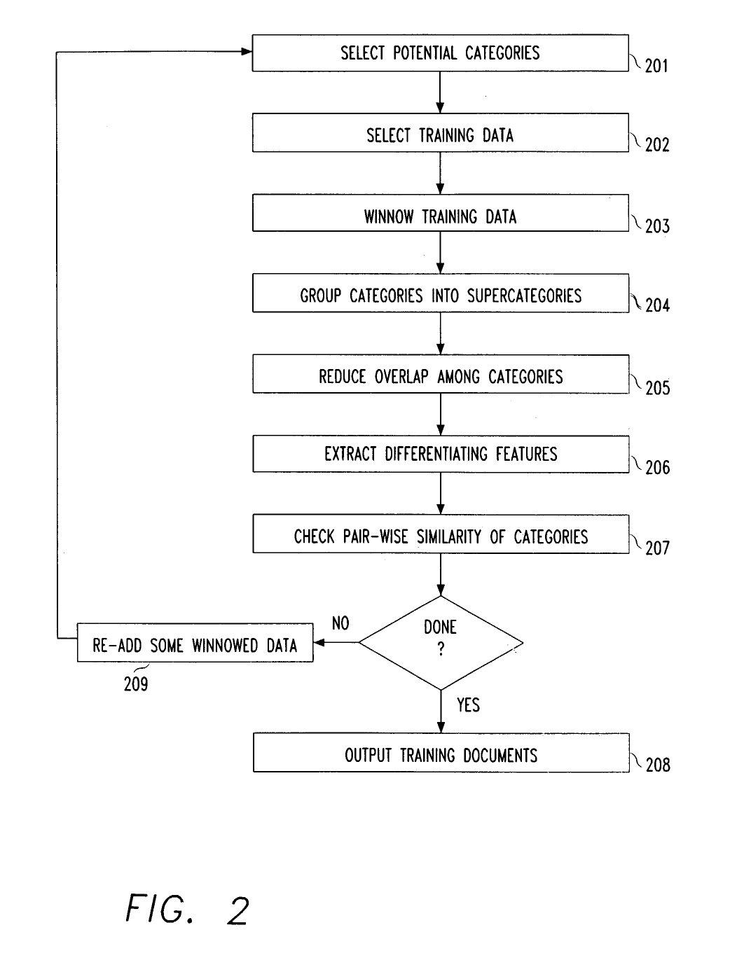

FIG. 2 shows the details of the third means of step 101, namely the selection of training documents by the methods of copending application [DOCKET NUMBER: YOR920020149US1]. It begins with step 201, the selection of a set or sets of potential categories for the categorization system. This selection is by any of a variety of means. One such means is to choose a subject area, and then successively divide it into logical subcategories. Another such means is to collect a large number of possible category names from a variety of sources. The categories can be, although do not need to be, arranged in any particular order or hierarchy. In general, this step works best if the categories selected are as non-overlapping as possible; i.e., if they are either conceptually as independent of one another as possible, or if they include as few features in common as possible. However, a useful criterion is that the categories be human-selected, so that they ultimately make sense to human users (in contrast to machine-selected categories, which often do not make sense to human users).

In step 202, training data is selected for each of the categories selected in step 201. Often, this is a list of training documents known or thought to be representative of each of the selected categories. Generally, for reasons of statistical sampling, the number of training documents is large, with a mix of documents from a number of different sources.

In step 203, the training data for each category from step 202 are winnowed down to a smaller set of training data, by applying some set of criteria. We have found that the most effective criteria are related to ensuring that each training document is purely on one topic, namely that of the category of interest.

In step 204, the training data obtained in step 203 from several related categories are optionally grouped into a supercategory using some supercategory formation criterion. It should be noted that if the categories are all closely related already, this step may not be necessary; however, for large heterogeneous systems of categories it is necessary to enable us both to reduce the computational requirements for solving the problem and to best pick out highly differentiating features (step 206 below).

In step 205, the grouped training data from step 204 are compared and overlap among categories within a supercategory reduced or eliminated.

In step 206, a set of differentiating features is extracted from the training data produced in step 205.

In step 207, pairs of categories with the highest similarity are examined to determine how to reduce the degree of overlap. The goal of this step and the preceding steps is to produce a set of features with a minimum degree of overlap between and among categories and supercategories. Overlap can be resolved by a number of means, including deleting one or more overlapping categories, picking new categories or training data, and by deleting or moving training documents from one category to another.

In step 208, the training data resulting from steps 201 through 207 is output to be used in step 102. This step may include storing the resulting training data on a disk or other mass storage device, or simply keeping it in computer memory for step 102.

Optionally, in step 209, we may, after step 207 or some other point in the process, use a re-addition criterion to add back into our set of training documents some of the documents eliminated in step 203 in order to increase the number of training documents. The most common source of documents to reinsert in our system is the documents omitted in step 203 and the decision whether to re-add the document is based upon it being sufficiently similar to the documents obtained after step 207.

In practice, some of steps 201-207 occur iteratively and some of the steps may occur simultaneously.

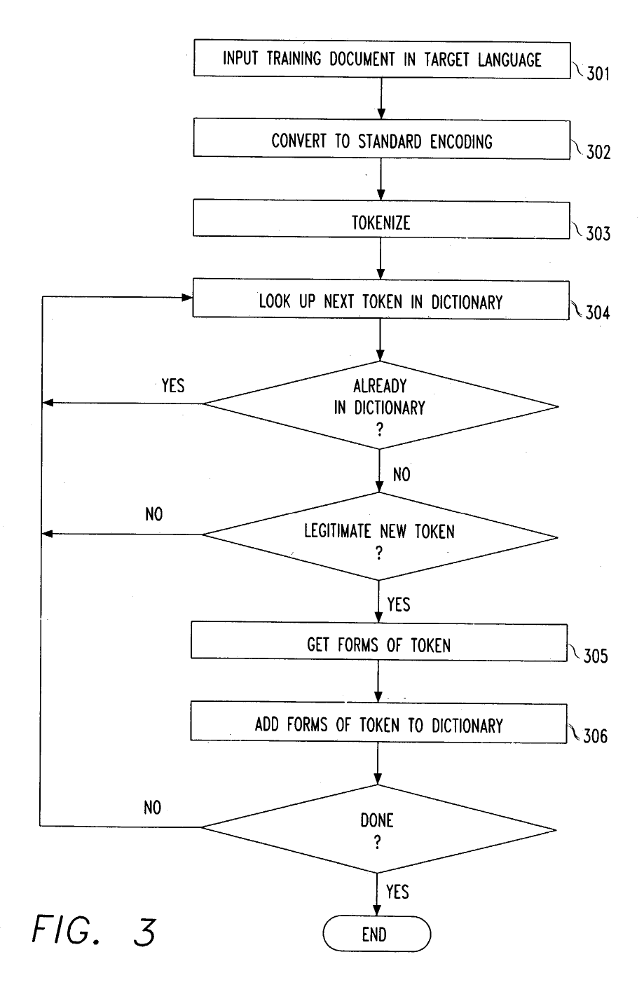

FIG. 3 shows the details of step 103, namely the creation of a dictionary of terms that can be used by the categorizer in step 110. This process can begin with obtaining one or more documents in the target language, step 301.

In step 302, the document is optionally converted to a standard encoding for easier processing. This step occurs because often documents in a particular language are represented (encoded) by a scheme that is specific to one or a few languages; however, processing is conveniently done when handling multiple languages by using a single encoding scheme for all of the languages.

In step 303, the document is tokenized, or converted to a mathematical representation for features such as a word or concept. In English, this may be as simple as looking for characters surrounded by spaces or other delimiters, but in other languages much more complex rules need to be used because words or concepts may not be separated by such delimiters.

Numerous systems known to the art are available for tokenizing documents in various languages.

In step 304, each token produced in step 303 is examined to see if it is already in the dictionary. If it is, we proceed to the next token. Otherwise, we test if the token is a legitimate token by, for example, comparing it to a list of valid tokens such as another existing dictionary or thesaurus, or by finding if it is a recognizable variant of a feature already in the dictionary (e.g, the past tense of a verb already in the dictionary). For those tokens that need to be added to the dictionary, we then in step 305 optionally discover other forms of the feature. This may be done by a variety of means, such as examining the document or a collection of documents for the forms, by using rules about how forms of features are created for a given feature type in a given language, by a knowledgeable human, or similar means. The forms could include known misspelling if desired.

In step 306, the new tokens and other forms of those tokens, if desired, are added to the dictionary. This might be a dictionary kept in a file, database, or in program memory.

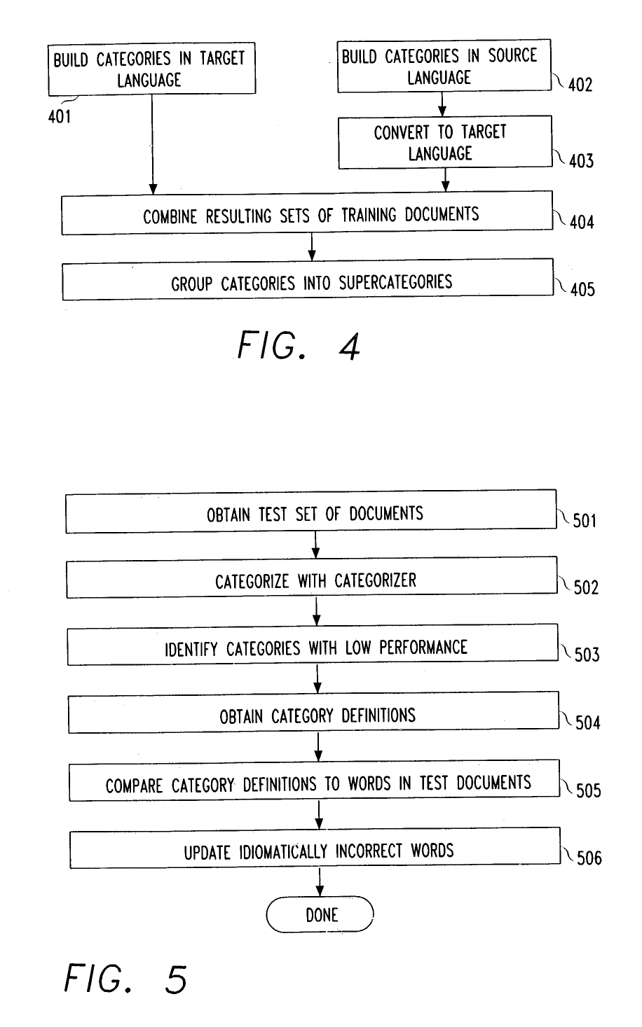

In practice, there are several useful variants of the above system. First, as described above, there are multiple means by which training documents can be collected in a target language (e.g., the means shown in FIGS. 1 and 2). These can usefully be combined. For example, these can be combined when there are sufficient training documents already in the target language to perform the methods of FIG. 2, as described in copending application [DOCKET NUMBER: YOR920020149US1], for some categories, but where there are insufficient numbers of training documents for other categories in the target language. In such a case, training documents from another (source) language are used according to the method of FIG. 1 for the latter set of categories, and the results combined as shown in FIG. 4.

Thus, in step 401, the training documents for one or more categories are built using the methods of FIG. 2. In step 402, training documents in another language are obtained and in step 403, converted to training documents in the target language according to the methods of FIG. 1.

In step 404, the resulting sets of training documents from steps 401 to 403 are combined.

Optionally, in step 405, the training data on related topics are grouped together in the same supercategory, regardless of whether the training documents for the categories were created by the methods of step 401 or by steps 402-403. The resulting data are then treated by steps 106-110 in FIG. 1 to produce and test the desired sets of category definitions for each category and each supercategory.

Another useful variant of this invention has been developed to deal with those cases where machine translation of source-language documents produces translations that are not idiomatically correct; in this case, the features selected (e.g., in step 107) may not be as useful as when training documents in the target language are used. This problem is most likely to occur in cases where the source and target languages are most dissimilar to one another, such as English and Chinese.

One method for solving this problem is shown in FIG. 5. Thus, in step 501, we obtain a set of one or more test documents in the target language (i.e., ones that use idiomatically-correct vocabulary for that topic in that language) for one or more categories. In step 502, these are categorized in a fashion similar to step 110. In step 503, we compare the results of the categorization to the categories known or expected to be represented by the test documents, and identify those categories where the precision, recall, or other measures of interest are lower than desired. This allows us to find the categories where there are likely to be problems with non-idiomatic translations. We then, in step 504, obtain the category definitions, such as the pseudo-centroids produced by the methods of copending application [DOCKET NUMBER: YOR920020149US1], and in step 505, compare the features to the features observed in the test documents to determine which features in the category definitions are most likely to be incorrectly translated. This can be done, for example, by comparing the most frequent features in the category definition to occurrences of the same concept in the test documents by a native speaker of the language, or by statistical comparisons of word frequencies between native and machine-translated documents. In step 506, the category definitions are updated to use the more idiomatically-correct words. Steps 502-506 can be repeated until the desired level of the measures of interest (e.g., precision or accuracy is obtained).

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

The foregoing has explained the pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments are meant to be construed to be merely illustrative of some of the more prominent features and applications of the invention. Thus the invention may be implemented by an apparatus including a processing unit and associated storage units and input/output units, or other means for performing the steps and/or functions of any of the methods used for carrying out the concepts of the present invention, in ways described herein and/or known by those familiar with the art. Other beneficial results can be realized by applying the disclosed invention in a different manner or modifying the invention in ways known to those familiar with the art.

We claim:

1. A method of creating a taxonomy and categorization system in a target language based on a set of training documents in a source language comprising the steps of:
selecting a source set of training documents in said source language, said set representing one or more categories;
translating said source set of training documents into a target set of target language training documents; and
extracting a set of differentiating features for each category from said target set.

2. A method according to claim 1, in which one or more members of said target set are removed from said target set, before said step of extracting a set of differentiating features, according to at least one removal criterion.

3. A method according to claim 2, in which said removal criterion is that one or more of said members of said target set are too dissimilar to other members of said target set by an amount that exceeds a removal threshold.

4. A method according to claim 1, further comprising a step of:
grouping at least one subset of said set of categories into at least one broader supercategory including said subset.

5. A method according to claim 4, further comprising a step of:
reducing overlap between categories within said broader supercategory.

6. A method according to claim 5, further comprising a step of sequentially comparing pairs of categories with the highest similarity and merging pairs of categories that satisfy a merge criterion.

7. A computer system for creating a categorization system in a target language based on a set of training data in a source language, comprising a processing unit for processing data and a storing unit for storing data, in which said processing unit contains instructions for executing a method comprising:
selecting a source set of training documents in said source language;
translating said source set of training documents into a target set of target language training documents; and
extracting a set of differentiating features, corresponding to a set of categories, from said target set.

8. A system according to claim 7, in which some members of said target set are removed from said target set, before said step of extracting a set of differentiating features, according to at least one removal criterion.

9. A system according to claim 8, in which said removal criterion is that one or more of said members of said target set are too dissimilar to other members of said target set by an amount that exceeds a removal threshold.

10. A system according to claim 7, further comprising a step of:
grouping at least one subset of said set of categories into at least one broader category including said subset.

11. A system according to claim 10, further comprising a step of:
reducing overlap between categories within said broader category.

12. A system according to claim 11, further comprising a step of sequentially comparing pairs of categories with the highest similarity and merging pairs of categories that satisfy a merge criterion.

13. A system according to claim 8, in which said step of removing some members of said target set is effected by a method further comprising:
selecting a set of potential categories:
selecting a set of training data;
eliminating some members of said set of training data; and
extracting differentiating features characteristic of an nth category that differentiate the nth category from other categories.

14. An article of manufacture in computer readable form comprising means for performing a method for operating a computer system having a program, said method comprising the steps of:
selecting a source set of training documents in said source language;
translating said source set of training documents into a target set of target language training documents; and
extracting a set of differentiating features, corresponding to a set of categories, from said target set.

15. An article of manufacture according to claim 14, in which:
some members of said target set, before said step of extracting a set of differentiating features, are removed from said target set according to at least one criterion.

16. A method according to claim 15, in which said removal criterion is that one or more of said members of said target set are too dissimilar to other members of said target set by an amount that exceeds a removal threshold.

17. A system according to claim 15, further comprising a step of:
grouping at least one subset of said set of categories into at least one broader category including said subset.

18. A system according to claim 17, further comprising a step of:
reducing overlap between categories within said broader category.

19. A system according to claim 18, further comprising a step of sequentially comparing pairs of categories with the highest similarity and merging pairs of categories that satisfy a merge criterion.

20. A system according to claim 15, in which said step of removing some members of said target set is effected by a method further comprising:
selecting a set of potential categories:
selecting a set of training data;
eliminating some members of said set of training data; and
extracting differentiating features characteristic of an nth category that differentiate the nth category from other categories.
